(19) United States
(12) Patent Application Publication
(10) Pub. No.: US 2026/0120547 A1
(43) Pub. Date: Apr. 30, 2026

(54) EMERGENCY DETECTION BASED ON CROWD SOURCED VISUAL INDICATORS

(71) Applicant: MOTOROLA SOLUTIONS, INC., CHICAGO, IL (US)

(72) Inventors: SEAN REGAN, DELRAY BEACH, FL (US); SCOTT G POTTER, COCONUT CREEK, FL (US); HAROLD DELGADO, HIALEAH, FL (US); NIYANTHRI RAMASWAMY NARESH PRABHU, CORAL SPRINGS, FL (US)

(21) Appl. No.: 18/931,512

(22) Filed: Oct. 30, 2024

(51) Int. Cl. G08B 5/00; G08B 5/36; G08B 21/02

(52) U.S. Cl. CPC G08B 5/002; G08B 5/36; G08B 21/02

(57) ABSTRACT

A device, system and method for detecting an emergency incident in high density environments is described. A first electronic device is associated with a first user. A second electronic device is associated with a second user. A first color is output by the first electronic device based on an activation action to indicate the first user needs assistance. An indication that the first electronic device has transitioned from a standby status to an alert status is received by the second electronic device and from the first electronic device. A distance between the first electronic device and the second electronic device is calculated based on the indication. A second color is output by the second electronic device based on the distance.

### BACKGROUND OF THE INVENTION

In some environments, especially involving high density environments, coordinating a response for emergency incidences may be challenging. In particular, when an individual, group, or other party is in need of assistance, it can be challenging for authorities or first responders to find those in need of assistance. Previse position and user information may be difficult to obtain in densely populated environments such as concerts, rallies, conferences, and festivals. Improving the ability of first responders to assist those who are in need of emergency medical or other assistance may be beneficial for reducing the occurrence of tragic incidents such as fatal crowd crush, overheating, and other tragic incidents.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts an example wearable electronic device for facilitating emergency detection, in accordance with some examples.

FIG. 2 depicts an example workflow for emergency detection based on crowd sourced visual indicators, in accordance with some examples.

FIG. 3 illustrates a block diagram of an example electronic device, in accordance with some examples.

FIG. 4 illustrate an example image sensor for detection of visual indicators for facilitating emergency detection, in accordance with some examples.

FIGS. 5A-5B each illustrate an example security ecosystem comprising a plurality of camera devices, in accordance with some examples.

FIG. 6 is a flowchart of a method for emergency detection based on crowd sourced visual indicators, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

It may be challenging to provide assistance (e.g., medical assistance) to those in need during an emergency incident at a high density environment such as a mass event (e.g., concern, festival, marathon etc.). For example, injuries and/or fatalities have tragically occurred from such emergency incidents at indoor or outdoor crowd crush events, overheating, and malicious attacks (e.g., casualties from gun attacks or bombings). In such distressing emergency situations, it can be difficult for emergency response personnel such as government authorities, private organizer staff, first responders, and the like to quickly and effectively respond to victims in need of emergency assistance. For example, individuals or parties located at the high density environment could be challenging for emergency responders to locate as a consequence of the density populated environment as well as unpredictable movement by those in need of assistance and unclear routing for responders to get to them.

Although many densely populated events occur without incident, this is unfortunately not always the case. Failure to provide prompt emergency assistance (e.g., emergency medical attention) can indirectly result in one or more casualties and/or serious harm. It may be desirable to improve emergency detection and response, including analyzing and coordinating an effective and timely response for emergencies in high density events. Visual indications, improved communication, and precise indications of position and other relevant information for those in need of assistance could improve the response of authorities and first responders to such emergencies as well as the outcomes (e.g., health) of those suffering emergencies.

The present disclosure provides a technical solution to the particular technical challenges of routing emergency services (e.g., medical attention) to victims or those in need of assistance in a high density environment described herein. In particular, a mechanism is provided for first responders to effectively detect and receive precise position and user information for victims based on a bracelet or other user electronic device that may communicate with other devices of other users in a mesh network (e.g., as crowd sourced visual indicators). For example, at a concert with a high density of attendees, a color scheme (e.g., dynamic color gradient) can be implemented on the user electronic devices to enable video analytics to detect an emergency situation and to determine a route to a target location as a response to that emergency situation. As an example, a user having a medical emergency during the concert may be detected and receive timely medical care based on a video camera configured to detect bracelets that are color coded to yellow and/or other colors to indicate the emergency situation is occurring and to effectively route emergency medical personnel to the user in need of assistance.

Accordingly, the disclosed technical solution beneficially may provide effective mesh communication of emergency status between subsets of the bracelets functioning as originator/transmitters and receivers of emergency status beacons. Such emergency status beacons may propagate emergency status to indicate the bracelet corresponding to the user having the medical emergency, for example. The propagated status can include the distance to the emergency victim user relative to the bracelet that is publishing the status or to the nearest “receiver” bracelet that is in range of the medical emergency bracelet.

In this way, emergency detection and response can be improved, especially in the context of densely populated or chaotic environments. Emergency services may respond more effectively by virtue of a visual indicator and clearly defined dynamically determined route to the emergency victim user (e.g., via the medical emergency bracelet). It should be noted that in some situations, emergency situation and location can advantageously be inferred based on the color gradient. For example, the medical emergency bracelet can flash red to indicate where emergency assistance is required while other bracelets can flash or pulse different colors according to distance away from the medical emergency bracelet to assist emergency responders (e.g., bracelet emitted color may change from yellow to orange as distance away from the medical emergency bracelet increases).

The emergency detection of the present disclosure may involve analytics by the video camera to detect the emergency situation, even if the bracelet (e.g., flashing red) or user electronic device of the individual(s) needing assistance is obstructed form view. For example, camera analytics can detect the presence of user bracelets flashing yellow worn by those users in the vicinity of the individuals(s) requiring emergency assistance. The camera analytics or signals from various bracelets can be used to calculate distance between the medical emergency bracelet and another bracelet or between a given bracelet and a different bracelet that is closer to the medical emergency bracelet as an aggregate distance. As such, the dynamically determined route can be effectively determined and adjusted for emergency responders even if the user having the medical emergency moves in the densely populated environment. The user bracelets also can encode user, location and other information pertinent to the emergency situation, such as via the color output by the bracelets (e.g., the bracelets can encode information by blinking, pulsing, flashing, and/or otherwise modulating color or visual patterns). For example, some helpful personal details (e.g., identifying features, type of medical emergency symptoms being experienced), and user identity can be encoded.

In this way, according to the disclosed technical improvement, the video camera can provide improved emergency detection routing, and emergency assistance in the challenging high density or chaotic environment, including more precise and timely routing of emergency response personnel and emergency triggers comprising useful encoded information on the emergency incident to be decoded by emergency response workflow management. Accordingly, as described through the present disclosure, the disclosed emergency detection will improve identification of emergency incidents and response by first responders where they are needed, especially in densely populated environments or situations.

According to one embodiment of the present disclosure, a computer-implemented method for improving emergency event detection such as in high density environments is provided. The method includes associating a first electronic device to a first user. The method includes associating a second electronic device to a second user. The method includes outputting, by the first electronic device and based on an activation action by the first user, a first color to indicate that the first user needs assistance. The method includes receiving, by the second electronic device and from the first electronic device, an indication that the first electronic device has transitioned from a standby status to an alert status. The method includes calculating, based on the indication, a distance between the first electronic device and the second in electronic device. The method includes outputting, by the second electronic device, a second color based on the distance.

According to one embodiment of the present disclosure, a system is provided that is configured for emergency event detection. The system includes: a first electronic device comprising a first display and a first transceiver configured to transmit an indication that the first electronic device has transitioned from a standby status to an alert status based on the emergency situation; a second electronic device comprising a second display and a second transceiver configured to receive the indication from the first transceiver; and an image sensor configured to detect an emergency situation based on visual signals, wherein the image sensor comprises a processor operatively in communication with the first electronic device and the second electronic device. The first and second electronic device are associated with a first and second user, respectively. The processor is configured to determine, based on an activation action by the first user, that first display of the first electronic device has output a first color to indicate that the first user needs assistance. The processor is configured to calculate, based on the indication, a distance between the first electronic device and the second electronic device. The processor is configured to transmit a command to the second electronic device to cause the second display to output a second color based on the distance. The processor is configured to detect, from the second electronic device and via the second color, encoded information associated with the emergency situation and the distance.

According to one embodiment of the present disclosure, an electronic device including a processor and a computer-readable storage medium is provided including instructions (e.g., stored sequences of instructions) that, when executed by the processor, cause the electronic device to perform a method for providing emergency event detection such as in high density environments. The electronic device also comprises a transceiver configured to receive an emergency signal from another electronic device and a display configured to output a color. The method includes determining the emergency signal has been received from another electronic device by the transceiver. The method includes determining, based on the emergency signal, an indication that the another electronic device has transitioned from a standby status to an alert status. The method includes calculating, based on the indication, a distance between the electronic device and the another electronic device. The method includes outputting, via the display and based on the distance, the color. The method includes encoding, via the color, information associated with an emergency situation and the distance, wherein the emergency situation corresponds to the emergency signal. The method includes rendering a change in the color based on a change in the distance.

Each of the above-mentioned embodiments will be discussed in more detail below, starting with example system and device architectures of the system in which the embodiments may be practiced, followed by an illustration of processing blocks for achieving an improved technical communication or data processing based method, device, and system for supporting rescue efforts in a building collapse scenario.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via cloud in any of a software as a service (Saas), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the drawings.

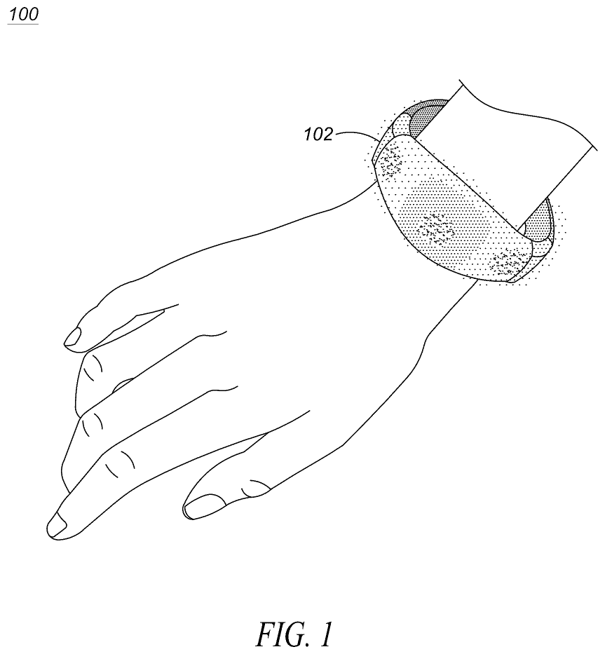

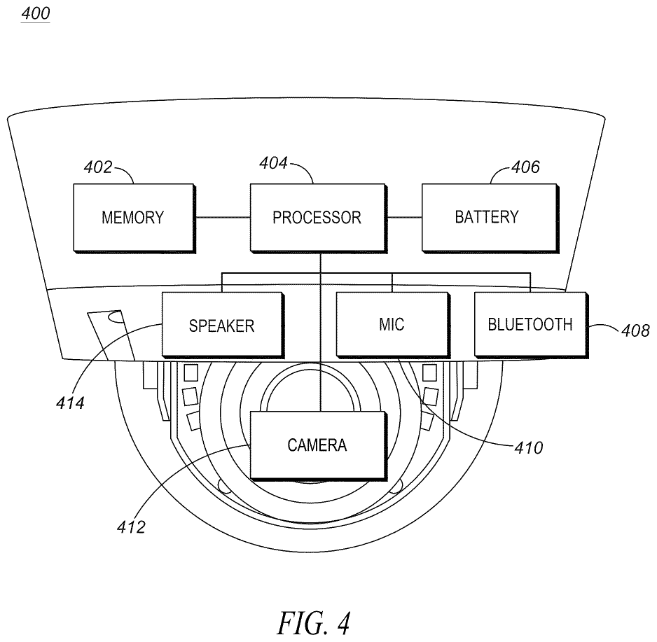

FIG. 1 is an illustration 100 that depicts an example wearable electronic device 102 for facilitating emergency detection, in accordance with some examples. The wearable electronic device 102 may comprise a wrist band, a bracelet, an ankle band, a neck band, a portable cellular communications device, or any suitable electronic device. The wearable electronic device 102 can also comprise a wearable electronic bracelet, such as depicted in FIG. 1. The wearable electronic bracelet 102 can be configured to communicate with other instances of bracelets 102, such as in a mesh communication network where multiples users participate in the network and each user has their own unique wearable bracelet 102 (e.g., each user can be associated with their corresponding electronic bracelet 102). The wearable electronic bracelet 102 may be in communication with one or more image sensors (e.g., video camera such as shown in FIG. 4) via the communication network. In this way, the electronic bracelets 102 and image sensor(s) in the network may interoperate to detect emergencies in various environments, such as high density environments.

For example, at a concert, a video camera could be configured or trained to detect specific signals from the electronic bracelets 102. As an example, the electronic bracelets could output color coded signals that could be identified by the video camera(s). To this end, the electronic bracelets 102 may comprise a digital display having pixels to emit light in different colors according to how the electronic bracelets 102 are programmed or trained. The display pixels can emit color as a combination of red, green, and blue sub-pixels at various desired light brightness and intensity levels. The light emitted by the electronic bracelets 102 could function effectively as crowd sourced visual indicators that the video camera is configured to detect in order to coordinate a response by emergency services.

As an example, the video camera may perform a suitable color imaging technique to determine bracelet emitted colors and infer distance away from the detected emergency according to a particular color gradient scheme. For example, the color gradient scheme can comprise a range of colors such as including yellow, red, orange, and intermediate mixes of colors. In this way, video camera analytics can assist in efficiently routing emergency responders to the location where they are needed to address the detected emergency. As an example, the color gradient can enable the emergency responders to infer their real time proximity to the emergency incident based on what variation of the colors is being emitted by the instances of electronic bracelets 102 in their vicinity. The wearable electronic bracelet 102 shown in FIG. 1 may output a color depending on an activation action by a user or based on a specific color output by another bracelet 102.

For example, the electronic bracelet 102 could output a red color based on the activation action by the user to indicate the user is experiencing an emergency such as a medical emergency and imminently requires medical attention. As another example, the electronic bracelet 102 could output yellow or orange color depending on determined proximity to the medical emergency bracelet 102 that is outputting red. The electronic bracelet 102 may comprise an electronic display to output visual signals and data as well as a transceiver (not shown in FIG. 1) to receive a broadcast emergency status from the medical emergency bracelet. The broadcast emergency status can be a Bluetooth low energy (BLE) emergency status beacon originated from the medical emergency bracelet 102 to all other bracelets 102 in the mesh communication network (e.g., at a densely populated environment). A beaconing distance of the emergency beacon can be calculated for determination of precise location of the emergency or relative distance away from the emergency. As described herein, when the transceiver of the electronic bracelet 102 receives the BLE emergency status, the electronic bracelet 102 may be configured to publish a propagated emergency status in the network.

The electronic bracelet 102 can determine that the medical emergency bracelet 102 has transitioned from a standby status to an alert status. The electronic bracelet 102 may calculated a distance between itself and another electronic bracelet 102, which can be a one to one distance or an aggregate distance and which can be used to output a particular color on the display of the electronic bracelet 102. For example, if the electronic bracelet 102 is in direct communication range of the medical emergency bracelet 102 (e.g., the electronic bracelet 102 can receive the MAC address of and distance from the originating medical emergency bracelet 102), then the electronic bracelet 102 can display a yellow color to help direct emergency services to the emergency incident (e.g., corresponding to the medical electronic bracelet 102).

If the electronic bracelet 102 is not in direct communication range, the propagated status can contain the distance to the nearest other receiver bracelet(s) 102 relative to the electronic bracelet 102 that can directly receive communication from the originating medical emergency bracelet 102. This may be particularly advantageous in terms of creating a direct route for emergency services to promptly arrive at where the emergency incident occurred. Additionally, the route can dynamically adjust depending on if/whether the person(s) experiencing the emergency or person(s) around the emergency incident move. The electronic bracelet 102 can use an aggregate/sum of distances to select and dynamically change what color or visual indication is displayed on the corresponding display. For example, according to one illustrative color scheme example, the electronic bracelet 102 can display yellow or a flashing/pulsing visual indication if they are closest, orange if they are closer, or blue if they are furthest.

That is, the network of bracelets 102 may function similar to moving geofences such that color can change as one gets closer to the emergency incident. It should be understood that different suitable visual indication colors and regimes can be used. The electronic bracelet(s) 102 may calculate distance based on the Pythagorean theorem (rather than straight line vectors, for example). The distance or aggregate distance can also be calculated by a remote computing component and received by the bracelets 102, such as by a processor of the video camera(s). The electronic bracelet(s) 102 can be capable of encoding additional information about the emergency incident or corresponding person into the color or visual indication that they output. The encoded information may be encoded based on pulsing lights or some other communication encoding or modulation method.

The encoded information could include personal information or medical history. Additional information can be received from paired devices in the mesh communication network, such as from a smartphone, smartwatch, statically provisioned data, or other device or source. The electronic bracelet(s) 102 may encode information about the distance or aggregate distance and also render a change based on a change in the distance. This dynamic adjustment of color can be beneficial for emergency situation detection and response by first responders. That is, emitted or output colors of wearable devices can be adjusted based on the wearer's movement and distance away from the origin/source of the emergency incident. For example, the video camera(s) and/or the emergency responders can see or perceive a cloud of yellow color, orange color, or other visual indicator to know precisely where they are in relation to the emergency incident or person(s) experiencing the emergency.

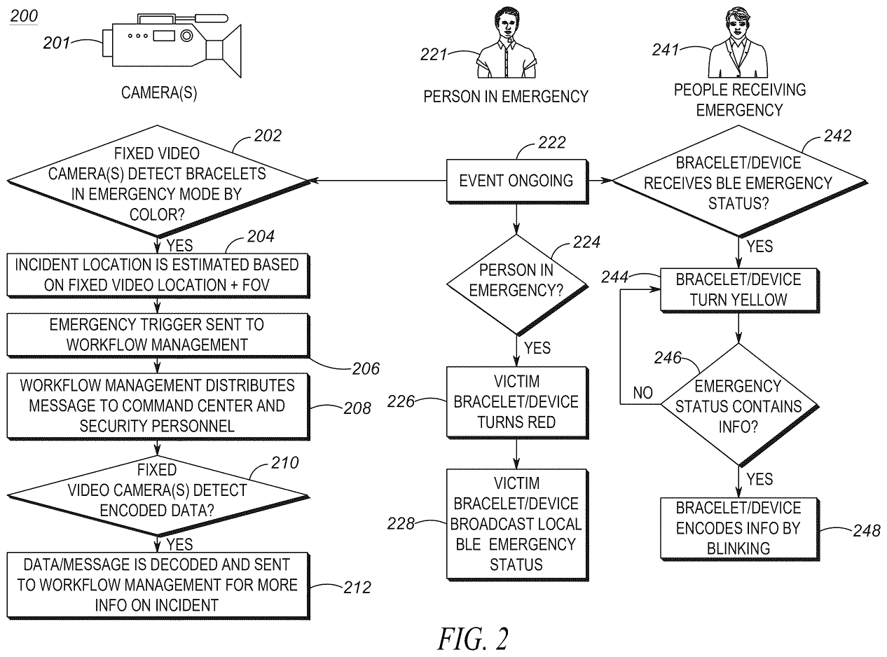

FIG. 2 depicts an example workflow 200 for emergency detection based on crowd sourced visual indicators, in accordance with some examples. As shown in FIG. 2, an image sensor such as a video camera 201 may interoperate with corresponding electronic devices including one worn by a person 221 experiencing an emergency incident and electronic devices worn by people 241 receiving a status of the emergency incident (e.g., published or propagated emergency status). There may be more than one video camera 201 in the workflow 200 and the video camera(s) 201 may be fixed in location. Advantageously, the workflow 200 for emergency detection improves both safety and a timely response from emergency responders, especially in densely populated environments such as concerts, marathons, or other highly crowded public events. The emergency detection of the public disclosure beneficially can alert for specific types of emergency help required as well as indicate the severity of the issue (e.g., via electronic device/bracelet encoded information).

Moreover, the disclosed emergency detection system and method may improve reliability due to mesh communication, real time feedback, and a wide range of messages or encoded information about the emergency incident including more precise location compared to manual notification of an emergency to emergency responders. In particular, the video camera(s) 201 may identify geographical areas with different emergency status easily due to the grouping of published/propagated alerts according to the dynamic color gradient described herein. Referring now to the workflow 200, at step 202, the video camera(s) 201 may detect electronic devices (e.g., electronic bracelets) that are in emergency mode based on a color signal or other visual signal. As described herein, the wearable electronic devices used by the people 221, 241 may be a wrist band, a bracelet, an ankle band, a neck band, a portable cellular communications device, or other electronic device. For example, the worn electronic devices can be electronic bracelets such as electronic bracelet 102 described in conjunction with FIG. 1.

At step 202, the electronic bracelets or devices worn by people at a particular high density environment may emit color via light emitting diodes, liquid crystals, or other photoelectric materials to output a particular color via a display component that indicates a particular status such as standby status, emergency alert status, or directional status. These color coded statuses can be detected by the video camera(s) 201 in the environment via filtering and processing camera captured light such as through a color filter array as well as visual frame processing and object detection if necessary. In this way, the video camera(s) 201 can detect bracelets in emergency mode based on those bracelets outputting a color or other visual signal indicative of a transition to an emergency alert status (e.g., emergency mode). As an example, the video camera(s) 201 may recognize that a particular bracelet is in emergency mode based on an output red color. The video camera(s) 201 can detect that a bracelet worn by a person experiencing an emergency (e.g., medical emergency) is emitting or flashing red, which can trigger a process for emergency response. That is, the emergency bracelet can emit or publish a red color to propagate an emergency status to indicate that an emergency incident has occurred.

To that end, at step 204, the emergency incident location corresponding to this person or persons can be estimated based on the video location and field of the video camera 201 that captured and detect the emergency signal. The video camera(s) can be trained to specifically detect certain color coded signals from the bracelets, such as via a suitable machine learning (ML) or artificial intelligence (AI) technique with training, preprocessing, validation against a labeled validation, and integration with the camera for video detection and object/signal classification. Such training can be based on a suitable ML/AI model such as a convolutional neural network (CNN) or other model. In the straightforward base scenario where a video camera 201 directly detects the emergency signal or status, at step 206 an emergency trigger may immediately be sent to workflow management, such as that of a security ecosystem comprising a network of the video cameras 201. The workflow management can be managed by the network of video cameras 201 with Internet of things (IOT) capabilities who can be in operative or wireless communication with other camera instances and the wearable electronic devices/bracelets (via component transceivers) in a mesh network. Based on the emergency trigger, at step 208, workflow management can distribute a message to command center of the security ecosystem and security personnel for managing an emergency response.

For example, the emergency response can involve rushing emergency medical personnel to the person(s) experiencing the emergency incident. Furthermore, at step 210, the video camera(s) 201 can detect encoded data from the emergency bracelet or other worn bracelets in the mesh network. The encoded data can be additional contextual data such as personal identification data (subject to privacy security measures), medical information (e.g., critical condition data such as allergies that can help medical personnel more timely and effectively save the person's life from the medical emergency), and other information the person shared when entering the high density environment (e.g., required data to enter such as if the environment was a densely populated concert). Encoded information can be encoded based on light modulation, such as through flashing or pulsing the output color or other visual signal by the bracelets according to amplitude, frequency, or phase modulation etc.

In addition, encoded information could be received from other devices in the network such as linked cell phones, smart watches, or fitness trackers. To this end, at step 212, the encoded data or message is decoded and sent to workflow management of the security ecosystem to obtain more information about the emergency incident to coordinate and facilitate a more effective response. In more complex scenarios to the base scenario, it may be difficult to promptly obtain a precise or exact location for the emergency incident in the densely populated environment. In such cases, the emergency incident detection of the present disclosure may improve emergency response by making it easier and quicker to detect and respond to the emergency incident. In particular, the network of electronic devices/bracelets and video camera(s) 201 can interoperate to improve routing emergency services to the emergency incident in a prompt manner. This can improve emergency detection and response especially because in the high density environment, people and objects can be very densely clustered so that it is challenging to move or see, posing difficulties for emergency services to actually arrive at the emergency incident location.

As such, at step 222, during the ongoing event, the person(s) 221 in the emergency can have their location and emergency situation detected via camera analytics based on the video camera(s) 201 inferring the person's location based on surrounding bracelets emitting signals. For example, the displays of surrounding bracelets can emit a yellow color based on a broadcast emergency status/signal from the emergency bracelet. The emergency status/signal can be broadcast via Bluetooth low energy (BLE), ultra wideband (UWB), or any other ad hoc or specified wireless communication or beaconing method or protocol. As an example, a beaconing distance of the emergency status/signal may be calculated for inferring the person's location. The yellow color may be used to infer by the video camera(s) 201 via camera analytics the precise location of the emergency incident or person experiencing the emergency. In this way, the color or visual signals by surrounding or other bracelets in the network relative to the emergency bracelet can function as directional cues or information to help emergency services in arriving at the emergency incident.

It should be noted that even though the emergency signals are described as a red color for emergency status and a yellow color for propagated emergency status, other colors can be used according to a defined color gradient or scheme that the video camera(s) 201 are trained to detect. As described in FIG. 2, at step 224, when the person(s) is determined to be in the emergency, such as via an activation action, the emergency bracelet can begin transmitting and broadcasting an emergency status signal or alert via its component transceiver. The activation action could be any defined action to indicate that the emergency bracelet should transition from standby status to alert status, such as tapping on the bracelet, entering a specific code, holding a physical button of the bracelet, or any other suitable method or action. Based on the activation action, at step 226, the emergency bracelet can turn red and begin outputting or flashing the red color via its display, as appropriate.

In this way, at step 228, the emergency bracelet acts as an originator to broadcast a local BLE emergency status, which can be received by other devices in the network. As an example, at step 242, other worn bracelets at the densely populated environment may act as receivers to receive the broadcast BLE emergency status signal or alert. The bracelets, video camera(s) 201, or other some other network supported computer processing component can determine, in isolation or in combination, each of the distances between various devices. For example, at any given moment, a distance between the originator emergency bracelet and any receiver bracelet or a distance between two receiver bracelets can be calculated such as via triangulation, the Pythagorean theorem, satellite positioning, wireless signal strength positioning, or any suitable method.

When the distance is calculated, the receiver bracelets can publish a propagated emergency status which involves outputting a different color from the color output by the originator bracelet (in the example given, these colors are red and yellow, but other colors can be used according to the color scheme being used). If the receiver bracelet is not within a threshold distance (e.g., the receiver bracelet cannot “see” the originator bracelet), then the propagated status can contain the distance to the closest receiver that is within the threshold distance as well as the identifier of the closest receiver or contain the chain of receiver/distances relative to the originator bracelet. If the receiver bracelet is within a threshold distance, then the propagated emergency status can contain the media access control (MAC) address or other identifier of the originator bracelet and the distance of the receiver to the originator. In this way, the broadcast emergency status and propagated status advantageously can leverage the network of devices to provide dynamic and multiple distance or routing cues to assist emergency services in arriving at the emergency incident location.

As such, at step 246, if the broadcast status contains emergency contextual information, then a corresponding receiver bracelet can encoded this contextual information by blinking, pulsing, or any suitable encoding method. As an example, the encoded information could indicate that the victim wearing the emergency bracelet is a diabetic, which can be useful to emergency services and medical personnel for addressing the medical emergency. At step 236, if the broadcast status does not contain emergency contextual information, then the receiver bracelet turns yellow (or outputs whatever color is defined by the color scheme) to propagate the emergency status to other devices in the network. This yellow or other color can be different or changes as the distance between the originator bracelet and the corresponding receive bracelet increases. That is, the color scheme can define a color gradient according to how far a particular receiver bracelet is from another receiver bracelet and relative to the originator bracelet. The color gradient scheme can include intermediate colors between primary colors (e.g., yellowish orange such as ochre color), which can be emitted by the display of bracelets according to their relative location in order to indicate relative distances from the emergency origin.

As an illustrative example, the color gradient can define a bullseye type configuration such as a red color for the originator at the center of the bullseye, a yellow color for the inner most ring, an orange color for the next outer ring, a blue color for the more outer ring relative to the orange, a black color for the next outer ring, and a white color for the outer most ring of the bullseye. Past the outer most ring of the bullseye, a wearable electronic device or bracelet may cease to emit light of any color. Thus, different color gradients can provide more refined location information. Accordingly, the video camera(s) 201 can be configured to detect color and visual signals according to this color gradient scheme so that camera analytics can determine or infer the origin of the emergency incident and an optimal or effective route for emergency services to travel to the origin. The distance between rings of the bullseye color gradient can be defined as suitable according to what can facilitate emergency response.

For example, the yellow color ring can be defined as within three feet of the emergency origin while the orange color ring can be defined as between three and six feet of the emergency origin, and so on. The video camera(s) 201 can recognize a propagated emergency status transmitted by any of the bracelets whether they are the originator or a receiver bracelet. Thus, the rebroadcasting and propagation of emergency status throughout the network advantageously improves emergency response by enabling emergency services to receive an updating indication of where they are relative to the emergency incident origin and/or what route/direction to take in order to get to the emergency incident origin. As described above, the distance being calculated can be calculated between a particular receiver bracelet and another receiver bracelet or the originator bracelet(s). Additionally or alternatively, the calculated distance may be calculated as an aggregated or sum of distances between the receiver bracelets and the originator bracelets to select and dynamically change their visual indicator or color according to the color gradient scheme.

That is, the aggregate distance can be defined as the sum of distances between the various devices involved in a “route” between the emergency incident origin and the start location (e.g., where emergency services is currently located). It should be noted that the detected emergency incident could include more than one originator bracelet, so the disclosed system and method can be replicated/expanded to account for the additional instance(s) of originator bracelets. It should also be noted that the wearable electronic devices used in the disclosed system and method could instead be a smartphone or other device and other devices such as smartwatches or fitness trackers could initiate emergency alerts or statuses as disclosed based on fall detection or health monitoring status, for example.

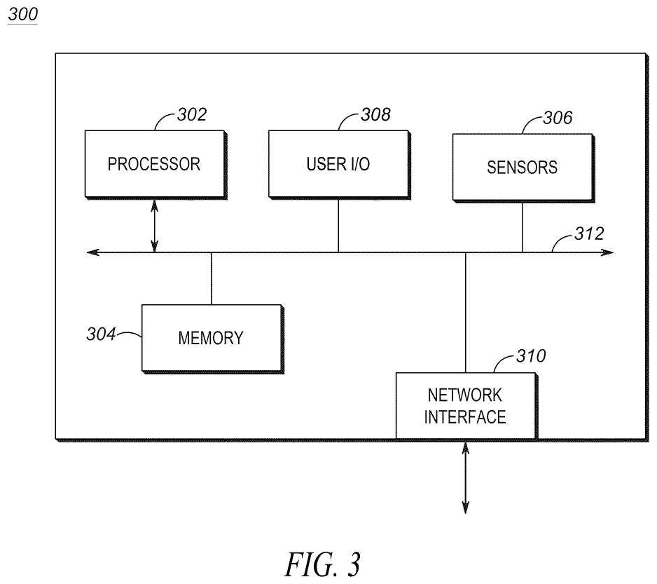

FIG. 3 illustrates a block diagram of an example electronic device, in accordance with some examples. In some embodiments, the computer device 300 may be a personal device, such as wearable user equipment (e.g., a wearable electronic device, a wrist band, a bracelet, an ankle band, a neck band, or a portable cellular communications device, etc.), or a network device, or other equipment used in a network environment. The computer device 300 may include a physical device and/or a virtual device, such as a server running one or more virtual network functions (VNFs) of a network. The computer device 300 may be able to transmit and receive signals, such as emergency status broadcast signal, which can be a visual indication according to a defined color gradient or scheme. In this way, the computer device 300 can broadcast, publish, and/or propagate emergency signals comprising dynamically changing color, gradients, or appearance according to distance from originator device or another receiver device. This depiction of distance advantageously can facilitate emergency response to the person(s) in emergency at the emergency incident origin location.

In various examples, the computer device 300 may be a processor, a specialized computer, a personal or laptop computer (PC), a tablet PC, a mobile telephone, a smartphone, a network router, switch or bridge, a circuit such as an application specific integrated circuit (ASIC) or field programmable gate array (FPGA), or any machine capable of executing instructions (sequential or otherwise) that specify actions to be taken by that machine. The computer device 300 could be a remote computing device that is in operative communication with electronic devices (e.g., a video camera, wearable electronic devices in a mesh network, etc.) In some embodiments, the computer device 300 may be an internet-of-things (IOT) or a narrowband IoT (NB-IOT) device or other device embedded within other, non-communication-based devices such as appliances or vehicles. The computer device 300 may render a user interface for emergency incident detection and response, which can included coordination of emergency medical assistance.

The computer device 300 may include various components connected by a bus 312. The computer device 300 may include a hardware processor 302 such as one or more central processing units (CPUs) or other processing circuitry able to provide any of the functionality described herein when running instructions. The processor 302 may be connected to a memory 304 may include a non-transitory machine-readable medium on which is stored one or more sets of instructions. The memory 304 may include one or more of static or dynamic storage, or removable or non-removable storage, for example. A machine-readable medium may include any medium that is capable of storing, encoding, or carrying instructions for execution by the processor 302, such as solid-state memories, magnetic media, and optical media. The machine-readable medium may include, for example, Electrically Programmable Read-Only Memory (EPROM), Random Access Memory (RAM), or flash memory.

The instructions may enable the computer device 300 to operate in any manner thus programmed, such as the functionality described specifically herein, when the processor 302 executes the instructions. The machine-readable medium may be stored as a single medium or in multiple media, in a centralized or distributed manner. In some embodiments, instructions may further be transmitted or received over a communications network via a network interface 310 utilizing any one of a number of transfer protocols (e.g., frame relay, internet protocol (IP), transmission control protocol (TCP), user datagram protocol (UDP), hypertext transfer protocol (HTTP), etc.).

The network interface 310 may thus enable the computer device 300 to communicate data and control information (e.g., security information) with other devices via wired or wireless communication. The network interface 310 may include electronic components such as a transceiver that enables serial or parallel communication. The wireless connections may use one or more protocols, including Institute of Electrical and Electronics Engineers (IEEE) Wi-Fi 802.11, Long Term Evolution (LTE)/4G, 5G, Universal Mobile Telecommunications System (UMTS), or peer-to-peer (P2P), for example, or short-range protocols such as Bluetooth, Zigbee, or near field communication (NFC). Wireless communication may occur in one or more bands, such as the 800-900 MHz range, 1.8-1.9 GHz range, 2.3-2.4 GHz range, 60 GHz range, and others, including infrared (IR) communications. Example communication networks to which computer device 300 may be connected via network interface 310 may include a local area network (LAN), a wide area network (WAN), a packet data network (e.g., the Internet), mobile telephone networks (e.g., cellular networks), and wireless data networks. The computer device 300 may be connected to the networks via one or more wired connectors, such as a universal serial bus (USB), and/or one or more wireless connections, and physical jacks (e.g., Ethernet, coaxial, or phone jacks) or antennas.

The computer device 300 may further include one or more sensors 306, such as one or more of an image sensor, metal sensor, accelerometer, a gyroscope, a global positioning system (GPS) sensor, a thermometer, a magnetometer, a barometer, a pedometer, a proximity sensor, a door sensor, or an ambient light sensor, among others. The sensors 306 may include some, all, or none of one or more of the types of sensors above (although other types of sensors may also be present), as well as one or more sensors of each type. The sensors 306 may be used in conjunction with one or more user input/output (I/O) devices 308 to indicate information on a user interface dashboard, such as transmitter or receiver bracelet information as well as contextual and emergency location information. The user I/O devices 308 may include one or more of a display (e.g., a touch screen display of a mobile computing device), a camera, a speaker, a keyboard, a microphone, a mouse (or other navigation device), or a fingerprint scanner, among others. The user I/O devices 308 may include some, all, or none of one or more of the types of I/O devices above (although other types of I/O devices may also be present), as well as one or more I/O devices of each type.

The computer device 300 may include different specific elements depending on the particular device. For example, although not shown, in some embodiments, computer device 300 may include a front end that incorporates a millimeter and sub-millimeter wave radio front end module integrated circuit (RFIC) connected to the same or different antennae. The RFICs may include processing circuitry that implements processing of signals for the desired protocol (e.g., medium access control (MAC), radio link control (RLC), packet data convergence protocol (PDCP), radio resource control (RRC) and non-access stratum (NAS) functionality) using one or more processing cores to execute instructions and one or more memory structures to store program and data information. The RFICs may further include digital baseband circuitry, which may implement physical layer functionality (such as hybrid automatic repeat request (HARQ) functionality and encoding/decoding, among others), transmit and receive circuitry (which may contain digital-to-analog and analog-to-digital converters, up/down frequency conversion circuitry, filters, and amplifiers, among others), and RF circuitry with one or more parallel RF chains for transmit/receive functionality (which may contain filters, amplifiers, phase shifters, up/down frequency conversion circuitry, and power combining and dividing circuitry, among others), as well as control circuitry to control the other RFIC circuitry.

FIG. 4 depicts an image sensor such as a video camera device 400, in accordance with some examples. The camera device 400 can have object detection capabilities such that it operates to identify and disambiguate between different objects. For example, the camera device 400 can be configured to identify and distinguish different types of objects such as a person, electronic device, and car. In addition, the camera 400 may have color imaging capabilities such that it can identify color coded or other visual signals, such as from the electronic devices or bracelets as described herein. The camera device 400 can determine bracelet emitted colors and infer distance away from the detected emergency according to a particular color gradient scheme. More generally, the camera 400 may recognize visual signals or particular emitted colors from electronic devices or bracelets in a mesh network for a high density environment to identify that an emergency alert status is being broadcast or published in order to determine that an emergency incident has occurred and/or a precise location or direction for emergency services to arrive at the emergency incident. To this end, the camera device 400 may be configured to perform color filtering, sampling, interpolating, color encoding or decoding, and signal processing, if necessary. As shown in FIG. 4, the camera device 400 is a video camera performing video analytics features (e.g., emergency incident and location detection, appearance search, analysis) with components including a memory 402, a processor 404 operatively connected to the memory 402, a battery 406, a Bluetooth component 408, a microphone 410, an camera component 412, and a speaker 414.

The memory 402 can be configured to store data and be in operative communication with the processor 404 for executing various operations. The memory 402 may comprise volatile or non-volatile memory components, including but not limited to RAM (Random Access Memory), ROM (Read-Only Memory), flash memory, or any other suitable storage medium. The processor 404 is configured to control the operation of the camera device 400, process captured signals, images and videos, store identity and other information about detected objects, execute other algorithms for analysis and detection, and manage communication with external devices. For example, the analysis performed by the processor 404 may include analysis of visual color signals to recognize an emergency incident and to determine a dynamic route to an origin of the emergency incident according to a color gradient scheme. The built in battery 406 of the camera device 400 may ensure uninterrupted operation and enhanced mobility. The battery 406 stores power and provides power to the various components of the camera device 400. In this way, the camera device 400 does not have to be plugged in at all time; that is, the camera device may function independently of external power sources for extended periods. The built in battery 406 may be rechargeable and designed to withstand frequent charging cycles for prolonged usage in video surveillance.

The Bluetooth component 408 can support wireless connectivity via short-range wireless communication (e.g., 2.4 GHz ISM frequency band) with compatible devices by the video camera device 400. The Bluetooth module 408 may enable seamless pairing with smartphones, tablets, or other Bluetooth-enabled computing/communication devices, allowing users to remotely access and control the camera device 400. Moreover, Bluetooth connectivity provided by the Bluetooth component 408 can facilitate data exchange, configuration, firmware updates, and other ad-hoc communication based capabilities. Although the camera device 400 is described as comprising the Bluetooth component 408, any other suitable wireless or wired communication method/component is also contemplated by the present disclosure. For example, the camera device 400 can use other wireless technology modalities such as Wi-Fi, Zigbee, RFID, Infrared (IR communication), or Near Field Communication (NFC). As understood in the art, Wi-Fi may operate based on IEEE 802.11 standards allowing devices to communicate through access points, Zigbee may enable low-power wireless communication, RFID may enable wireless identification and tracking of objects via radio frequency (RF) signals, IR may enable wireless data communication with IR waves, and NFC may enable very short range wireless communication (e.g., devices in close proximity).

The camera device 400 also comprises a microphone 410 and speaker 414 suite to facilitate two-way audio communication. The speaker 414 can perform playback of audio signals, including alerts, notifications, and voice messages. For example, as discussed herein, the speaker 414 can generate an audible alert indicating the presence of a emergency situation, path, or other object or event of interest. The microphone 410 captures ambient sounds and user-generated audio inputs. For example, the microphone 410 can capture audio response (e.g., human natural language for audio controlled commands) from users. The microphone 410 and speaker 414 may provide interactive capabilities for the camera device 400, enabling real-time communication between users and monitored areas, for example.

The camera component 412 may be a suitable high-resolution camera capable of capturing clear and detailed images and videos. As an example, the camera component 412 can utilize advanced imaging technology, including but not limited to CMOS (Complementary Metal-Oxide-Semiconductor) sensors, lenses, and image processing algorithms, to perform its image capture functionality for video capture and/or surveillance. The camera component 412 can have adjustable settings for resolution, frame rate, and exposure, such that it adapts to various lighting and environmental conditions to achieve optimal image quality and coverage.

As discussed herein, the video camera device 400 may be a video camera for capturing video footage of a specific area for surveillance or monitoring purposes, such a densely populated environment. The video camera device 400 may include an image sensor used to convert light into electronic signals to capture images or video frames on the sensor's surface. The video camera device 400 can be configured to perform processing, analysis, and other manipulation of signals, images, or videos that it has captured or detected. In this way, the camera 400 can determine occurrence of an emergency incident and dynamically determine (and adjust) a path or paths to the origin of the emergency incident for emergency responders.

The video camera device 400 may perform analog to digital conversion (A-D conversion) of a captured analog video signal, transmission (e.g., real-time transmission over coaxial or Ethernet cables or wirelessly to a monitoring station or recording/storage medium), and control and monitoring. For example, the video camera device 400 can have features such as pan, tilt, zoom (PTZ) functionality, motion detection, night vision (infrared illumination), and remote access for configuration and viewing via computer software, mobile apps, or web browsers. Video footage or analysis from the video camera device 400 or any other cameras connected to it can be stored for later viewing, analysis, or archival purposes.

The video camera device 400 may be connected to multiple other cameras or devices in a network, such as one that forms a security ecosystem as described herein. In this way, the security ecosystem can monitor multiple or broader areas for surveillance and monitoring. Furthermore, the video camera device 400 may perform various video analytics algorithms which may or may not include ML/AI aspects. As an example, the video camera device 400 can perform various computer vision techniques for object detection (e.g., identifying and locating objects of interest within video footage in real-time or offline). An example video object detection algorithm includes capturing an input video stream over time from a camera feed, pre-processing the frame to improve accuracy (e.g., resizing, normalization, noise reduction, color space conversion, etc.), object detection (e.g., using convolutional neural networks (CNNs) for recognizing objects by learning hierarchical features), feature extraction (e.g., to identify colors, textures, shapes and other visual characteristics for object recognition), object localization (e.g., with bounding boxes), classification, post-processing to refine results and improve accuracy, and output visualization. For example, the video camera device 400 may perform video analytics on input video camera data via preprocessing, feature extraction, event detection (e.g., detecting motion, tracking objects, recognizing gestures, identifying anomalies), object recognition, pattern recognition, and contextual understanding. It will be understood that other suitable algorithms can be performed by the camera 400.

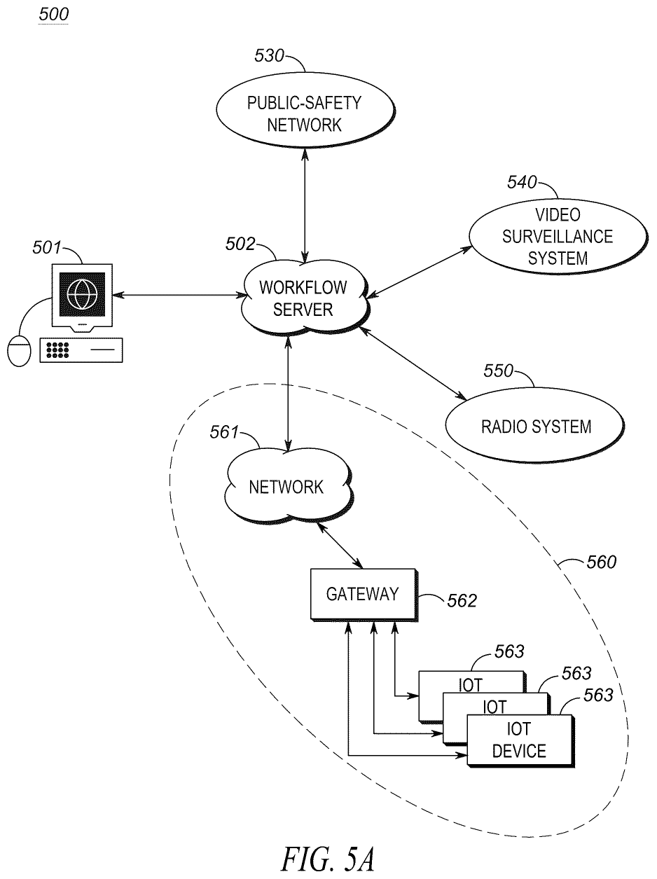

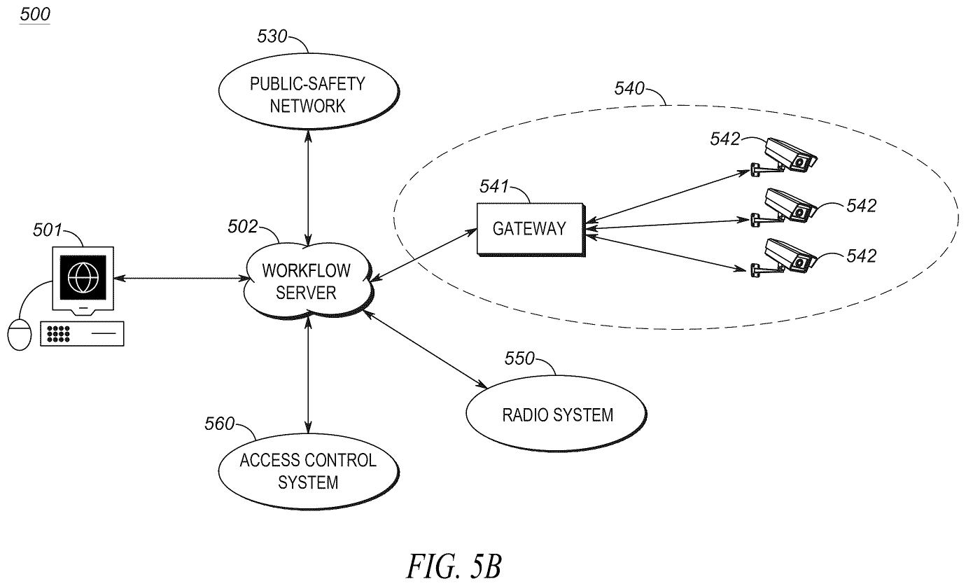

FIGS. 5A-5B each illustrate a security ecosystem 500 comprising a plurality of camera devices, in accordance with some examples. The security ecosystem 500 can be capable of monitoring an environment (e.g., highly densely populated environment) for emergency event detection and routing emergency services to respond to the detected emergency event (e.g., to provide emergency medical assistance). FIG. 5A illustrates the security ecosystem 500 capable of configuring and automating workflows across multiple systems. As shown, the security ecosystem 500 comprises a public-safety network 530, a video surveillance system 540, a private radio system 550, and an access control system 560. The workflow server 502 is coupled to each system 530, 540, 550, and 560. The workstation 501 is shown coupled to the workflow server 502, and is utilized to configure server 502 with workflows created by a user. It should be noted that although the components in FIG. 5 are shown geographically separated, these components can exist within a same geographic area, such as, but not limited to a building, a school, a hospital, an airport, a sporting event, concert, marathon, a stadium, etc. It should also be noted that although only the networks and systems 530-560 are shown in FIG. 5A, one of ordinary skill in the art will recognize that many more networks and systems may be included in ecosystem 500.

The workstation 501 is preferably a computer configured to execute dispatch and incident management software. As will be discussed in more detail below, the workstation 501 is configured to present a user with a plurality of triggers capable of being detected by the network and systems 530-560 as well as present the user with a plurality of actions capable of being executed by the network and systems 530-560. The user will be able to create workflows and upload these workflows to the workflow server 502 based on the presented triggers and actions. For example, an example trigger is an emergency trigger sent from or to the workstation 501. This can cause a message to be sent to emergency responder personnel to respond to a detected incident such as an emergency medical incident at a concert, for example.

The workflow server 502 is preferably a server running a command center software and platform. The workflow server 502 is configured to receive workflows created by the workstation 501 and implement the workflows. Particularly, the workflows are implemented by analyzing events detected by the network and systems 530-560 and executing appropriate triggers. For example, assume a user creates a workflow on the workstation 501 that has a trigger comprising the surveillance system 540 detecting a loitering event, and has an action comprising notifying radios within the public-safety network 530. When this workflow is uploaded to the workflow server 502, the workflow server 502 will notify the radios of any loitering event detected by the surveillance system 540. As an example, the workflow server 502 may be configured to decode encoded data, such as data encoded on visual or color coded signals broadcast or propagated by/within a network of electronic devices.

The public-safety network 530 is configured to detect various triggers and report the detected triggers to the workflow server 502. The public-safety network 530 is also configured to receive action commands from the workflow server 502 and execute the actions. In one embodiment of the present invention, the public-safety network 530 comprises includes typical radio-access network (RAN) elements such as base stations, base station controllers (BSCs), routers, switches, and the like, arranged, connected, and programmed to provide wireless service to user equipment, report detected events, and execute actions received from the workflow server 502.

The video surveillance system 540 is configured to detect various triggers and report the detected triggers to the workflow server 502. The public-safety network 530 is also configured to receive action commands from workflow server 502 and execute the actions. For example, the video surveillance system 540 comprises a plurality of video cameras that may be configured to automatically change their field of views over time. The video surveillance system 540 is configured with a recognition engine/video analysis engine (VAE) that comprises a software engine that analyzes any video captured by the cameras. Using the VAE, the video surveillance system 540 is capable of “watching” video to detect any triggers and report the detected triggers to workflow server 502. Similarly, the video surveillance system 540 can execute action commands received from the workflow server 502. As described herein, the triggers and action commands can be for emergency incident detection, routing, response, and data analysis (e.g., determining the identity of a person experiencing an allergic medical reaction emergency and what they are actually allergic to as well as other medical sensitivities).

The radio system 550 preferably comprises a private enterprise radio system that is configured to detect various triggers and report the detected triggers to the workflow server 502. The radio system 550 is also configured to receive action commands from workflow server 502 and execute the actions. For example, the radio system 550 may comprise a MOTOTRBO™ communication system having radio devices that operate in the CBRS spectrum and combines broadband data with voice communications.

The access control system 560 may comprise an IoT network. The IoT system 560 serves to connect every-day devices to the Internet. Devices such as cars, kitchen appliances, medical devices, sensors, doors, windows, HVAC systems, drones, . . . , etc. can all be connected through the IoT. Basically, anything that can be powered can be connected to the internet to control its functionality. The system 560 allows objects to be sensed or controlled remotely across existing network infrastructure. For example, the access control system 560 may be configured to provide access control to various doors and windows. With this in mind, the access control system 560 is configured to detect various triggers (e.g., door opened/closed) and report the detected triggers to workflow server 502. As an example, the access control system 560 is configured to control access to a controlled access event (e.g., requiring a ticket to enter), such as a concert. The access control system 560 is also configured to receive action commands from the workflow server 502 and execute the action received from the workflow server 502. The action commands may take the form of instructions to lock, open, and/or close a door or window, or to allow a participant to enter.

As is evident, the above security ecosystem 500 allows an administrator using the workstation 501 to create rule-based, automated workflows between technologies to enhance efficiency, and improve response times, effectiveness, and overall safety. The above ecosystem 500 has the capability to detect triggers across a number of devices within the network and systems 530-560 quickly take actions by automatically executing the proper procedure (i.e., executing the appropriate action once a trigger is detected).

FIG. 5B illustrates a security ecosystem capable of configuring and automating workflows. In particular, FIG. 7B shows the security ecosystem 500 with an expanded view of access control system 560. As shown, the access control system 560 comprises a plurality of IoT devices 563 coupled to the gateway 562. Data passed from the workflow server 502 to the IoT devices 563 passes through the network 561, gateway 562 and ultimately to the IoT device 563. Conversely, data passed from the IoT devices 563 to the workflow server 502 passes through the gateway 562, network 561, and ultimately to the workflow server 502.

The IoT devices 563 preferably comprise devices that control objects, doors, windows, sensors, . . . , etc. As is known in the art, a particular communication protocol (IoT protocol) may be used for each IoT device. For example, various proprietary protocols such as DNP, Various IEC**** protocols (IEC 61850 etc.,), bacnet, EtherCat, CANOpen, Modbus/Modbus TCP, EtherNet/IP, PROFIBUS, PROFINET, DeviceNet, . . . , etc. can be used. Also a more generic protocol such as Coap, Mqtt, and RESTfull may also be used.

The gateway 562 preferably comprises an Avigilon™ Control Center running Avigilon's Access Control Management software. The gateway 562 is configured to run the necessary Application Program Interface (API) to provide communications between any IoT device 563 and the workflow server 502.

The network 561 preferably comprises one of many networks used to transmit data, such as but not limited to a network employing one of the following protocols: a Long Term Evolution (LTE) protocol, LTE-Advance protocol, or 5G protocol including multimedia broadcast multicast services (MBMS) or single site point-to-multipoint (SC-PTM) protocol over which an open mobile alliance (OMA) push to talk (PTT) over cellular protocol (OMA-PoC), a voice over IP (VOIP) protocol, an LTE Direct or LTE Device to Device protocol, or a PTT over IP (PoIP) protocol, a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

As discussed herein, the security ecosystem 500 is capable of configuring and automating workflows. In particular, FIG. 5B shows the security ecosystem 500 with an expanded view of the video surveillance system 540. As shown, the video surveillance system 540 comprises a plurality of cameras 542 and gateway 541. The cameras 542 may be fixed or mobile, and may have pan/tilt/zoom (PTZ) capabilities to change their field of view. The cameras 542 may also comprise circuitry configured to serve as a video analysis engine (VAE) which comprises a software engine that analyzes analog and/or digital video. The engine is configured to “watch” video and detect pre-selected objects such as license plates, people, faces, automobiles. The software engine may also be configured to detect certain actions of individuals, such as fighting, loitering, crimes being committed, . . . , etc. The VAE may contain any of several object/action detectors.

Each object/action detector “watches” the video for a particular type of object or action. Object and action detectors can be mixed and matched depending upon what is trying to be detected. For example, an automobile object detector may be utilized to detect automobiles, while a fire detector may be utilized to detect fires. The gateway 541 preferably comprises an Avigilon™ Control Center running Avigilon's Access Control Management software. The gateway 541 is configured to run the necessary Application Program Interface (API) to provide communications between any cameras 542 and the workflow server 502.

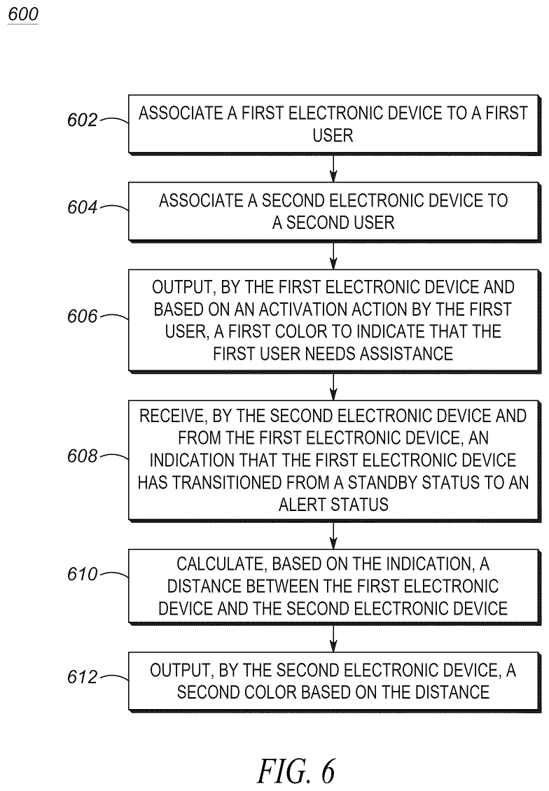

FIG. 6 illustrates an example flow diagram (e.g., process 600) for emergency event detection such as in high density environments, according to certain aspects of the present disclosure. For explanatory purposes, the example process 600 is described herein with reference to one or more of the figures above. Further for explanatory purposes, the blocks of the example process 600 are described herein as occurring in serial, or linearly. However, multiple instances of the example process 800 may occur in parallel, overlapping in time, almost simultaneously, or in a different order from the order illustrated in the process 600. In addition, the blocks of the example process 600 need not be performed in the order shown and/or one or more of the blocks of the example process 600 need not be performed.

At step 602, a first electronic device may be associated with a first user. As an example, the first electronic device comprises a first display and a first transceiver. The first transceiver is configured to transmit an indication that the first electronic device has transitioned from a standby status to an alert status based on an emergency situation. The first display is configured to output a color. As an example, the first electronic device comprises a processor operatively in communication with the first transceiver and the first display. The first electronic device comprises a computer-readable storage medium having stored thereon program instructions that, when executed by the processor, cause the electronic device to perform a set of operations for emergency incident detection and response. For example, the processor can determine, based on an activation action by the first user, that first display of the first electronic device has output a first color to indicate that the first user needs assistance.

At step 604, a second electronic device may be associated with a second user. As an example, the second electronic device comprises a second display and a second transceiver. The second transceiver is configured to receive an emergency signal from another electronic device. The emergency signal indicates that the other electronic device has transitioned from a standby status to an alert status based on the emergency situation. The second display is configured to output a color. An image sensor (e.g., video camera) configured to detect an emergency situation based on visual signals comprises a processor operatively in communication with the first electronic device and the second electronic device. The second electronic device is configured to publish or transmit a propagated emergency status to other devices. For example, the second electronic device may receive or transmit a command to cause the second display to output a second color based on a calculated distance. As an example, the first electronic device and the second electronic device each comprises at least one of: a wearable electronic device, a wrist band, a bracelet, an ankle band, a neck band, or a portable cellular communications device.

At step 606, a first color to indicate that the first user needs assistance may be output by the first electronic device and based on the activation action by the first user. For example, outputting the first color comprises outputting the first color as red to the first display, wherein the second color comprises yellow. For example, outputting the first color comprises transmitting a wireless signal to indicate an emergency status corresponding to the first user. For example, the first electronic device is configured to transmit a wireless beacon signal to indicate an emergency status corresponding to the first user. At step 608, an indication that the first electronic device has transitioned from a standby status to an alert status may be received by the second electronic device and from the first electronic device. For example, receiving the indication comprises determining, based on the first color or the second color, a nearest responder to dispatch to aid the first user. For example, receiving the indication comprises transmitting a dispatch request to a device associated with the nearest responder.

At step 610, a distance between the first electronic device and the second electronic device may be calculated based on the indication. For example, calculating the distance comprises determining that the second electronic device has received an emergency beacon transmitted by the first electronic device. For example, calculating the distance comprises measuring a beaconing distance of the emergency beacon. At step 612, a second color may be output by the second electronic device based on the distance. For example, outputting the second color comprises outputting the second color as yellow to the second display. For example, outputting the second color comprises determining, based on the color gradient, the second color according to a bullseye configuration. As an example, outputting the second color comprises determining the color gradient that defines how color varies as a function of the distance, wherein the color gradient is configured to facilitate routing the assistance to the first user. For example, outputting the second color comprises changing, based on the color gradient, the second color to another color based on a value of the distance. For example, outputting the second color comprises ceasing, based on the distance exceeding a threshold, to emit light of the second color.

According to an aspect, the process 600 comprises transmitting, by the second electronic device, a second indication that the first electronic device has transitioned from the standby status to the alert status, wherein the second indication indicates the distance between the first electronic device and the second electronic device. According to an aspect, the process 600 comprises receiving, by a third electronic device and from the second electronic device, the transmission of the second indication. According to an aspect, the process 600 comprises calculating an aggregate distance between the third electronic device and the second electronic device from the first electronic device. According to an aspect, the process 600 comprises determining an approximate location of the first user based on a color gradation of the second color.

According to an aspect, the process 600 comprises outputting, by the third electronic device, a third color based on the aggregate distance. According to an aspect, the process 600 comprises identifying, by an image sensor, a visual indicator comprising the first color or the second color output by the first electronic device or the second electronic device. According to an aspect, the process 600 comprises encoding, via the second color, information associated with the distance and an emergency situation experienced by the first user. According to an aspect, the process 600 comprises pulsing the second color to represent data corresponding to the first user. According to an aspect, the process 600 comprises detecting, from the second electronic device and via the second color, encoded information associated with the emergency situation and the distance.

According to an aspect, the process 600 comprises the second electronic device determining the emergency signal has been received from another electronic device by the transceiver. According to an aspect, the process 600 comprises the second electronic device determining, based on the emergency signal, an indication that the another electronic device has transitioned from a standby status to an alert status. According to an aspect, the process 600 comprises the second electronic device calculating, based on the indication, a distance between the electronic device and the another electronic device. According to an aspect, the process 600 comprises the second electronic device outputting, via the display and based on the distance, the color. According to an aspect, the process 600 comprises the second electronic device encoding, via the color, information associated with an emergency situation and the distance, wherein the emergency situation corresponds to the emergency signal. According to an aspect, the process 600 comprises the second electronic device rendering a change in the color based on a change in the distance.

According to an aspect, the process 600 comprises determining, based on the first color or the second color, a nearest responder to dispatch to aid a user. According to an aspect, the process 600 comprises transmitting a dispatch request to a device associated with the nearest responder. According to an aspect, the process 600 comprises determining that the second computing device has received an emergency beacon transmitted by the first computing device. According to an aspect, the process 600 comprises encoding, via the color, information associated with the distance and an emergency situation experienced by the user. According to an aspect, the process 600 comprises pulsing the color to represent data corresponding to the user.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, validate digital certificates, issue tokens, and the like).

In the foregoing specification, specific examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
associating a first electronic device to a first user;
associating a second electronic device to a second user;
outputting, by the first electronic device and based on an activation action by the first user, a first color to indicate that the first user needs assistance;
receiving, by the second electronic device and from the first electronic device, an indication that the first electronic device has transitioned from a standby status to an alert status;
calculating, based on the indication, a distance between the first electronic device and the second electronic device;
outputting, by the second electronic device, a second color based on the distance.

2. The method of claim 1, wherein outputting the first color comprises:
outputting the first color as red, wherein the second color comprises yellow; and
transmitting a wireless signal to indicate an emergency status corresponding to the first user.

3. The method of claim 1, wherein receiving the indication comprises:
determining, based on the first color or the second color, a nearest responder to dispatch to aid the first user; and
transmitting a dispatch request to a device associated with the nearest responder.

4. The method of claim 1, wherein calculating the distance comprises:
determining that the second electronic device has received an emergency beacon transmitted by the first electronic device; and
measuring a beaconing distance of the emergency beacon.

5. The method of claim 1, wherein outputting the second color comprises:
determining a color gradient that defines how color varies as a function of the distance, wherein the color gradient is configured to facilitate routing the assistance to the first user;
determining, based on the color gradient, the second color according to a bullseye configuration;
changing, based on the color gradient, the second color to another color based on a value of the distance; and
ceasing, based on the distance exceeding a threshold, to emit light of the second color.

6. The method of claim 1, further comprising:
transmitting, by the second electronic device, a second indication that the first electronic device has transitioned from the standby status to the alert status, wherein the second indication indicates the distance between the first electronic device and the second electronic device;
receiving, by a third electronic device and from the second electronic device, the transmission of the second indication;
calculating an aggregate distance between the third electronic device and the second electronic device from the first electronic device; and
outputting, by the third electronic device, a third color based on the aggregate distance.

7. The method of claim 1, further comprising:
identifying, by an image sensor, a visual indicator comprising the first color or the second color output by the first electronic device or the second electronic device; and
wherein the first electronic device and the second electronic device each comprises at least one of: a wearable electronic device, a wrist band, a bracelet, an ankle band, a neck band, or a portable cellular communications device.

8. The method of claim 1, further comprising:
encoding, via the second color, information associated with the distance and an emergency situation experienced by the first user; and
pulsing the second color to represent data corresponding to the first user.

9. A system comprising:
a first electronic device comprising a first display and a first transceiver, wherein the first transceiver is configured to transmit an indication that the first electronic device has transitioned from a standby status to an alert status based on the emergency situation, wherein the first electronic device is associated with a first user;
a second electronic device comprising a second display and a second transceiver, wherein the second transceiver is configured to receive the indication from the first transceiver, wherein the second electronic device is associated with a second user;
an image sensor configured to detect an emergency situation based on visual signals, wherein the image sensor comprises a processor operatively in communication with the first electronic device and the second electronic device; and
wherein the processor, upon executing program instructions, is configured to:
determine, based on an activation action by the first user, that first display of the first electronic device has output a first color to indicate that the first user needs assistance;
calculate, based on the indication, a distance between the first electronic device and the second electronic device;
transmit a command to the second electronic device to cause the second display to output a second color based on the distance; and
detect, from the second electronic device and via the second color, encoded information associated with the emergency situation and the distance.

10. The system of claim 9, wherein:
the first color is output as red to the first display;
the second color is output as yellow to the second display; and
the first electronic device is configured to transmit a wireless beacon signal to indicate an emergency status corresponding to the first user.

11. The system of claim 9, wherein the processor is configured to calculate the distance by being configured to:
determine that the second electronic device has received an emergency beacon transmitted by the first electronic device; and
measure a beaconing distance of the emergency beacon.

12. The system of claim 9, wherein the processor is configured to transmit the second command to the second electronic device by being configured to:
determine a color gradient that defines how color varies as a function of the distance, wherein the color gradient is configured to facilitate routing the assistance to the first user; and
determine, based on the color gradient, a change in the second color to another color based on a value of the distance.

13. The system of claim 9, wherein:
the image sensor is configured to detect the emergency situation based on identifying a visual indicator comprising the first color or the second color output by the first electronic device or the second electronic device;
the first electronic device and the second electronic device each comprises at least one of: a wearable electronic device, a wrist band, a bracelet, an ankle band, a neck band, a portable cellular communications device; and
the second electronic device is configured to display different colors on the second display as a function of a bullseye configuration that defines color change as the distance increases away from the first electronic device.

14. The system of claim 9, wherein the processor is further configured to determine an approximate location of the first user based on a color gradation of the second color.

15. An electronic device comprising:
a transceiver configured to receive an emergency signal from another electronic device;
a display configured to output a color; and
a processor operatively in communication with the transceiver and the display; and
a computer-readable storage medium having stored thereon program instructions that, when executed by the processor, cause the electronic device to perform a set of operations comprising:
determining the emergency signal has been received from another electronic device by the transceiver;
determining, based on the emergency signal, an indication that the another electronic device has transitioned from a standby status to an alert status;
calculating, based on the indication, a distance between the electronic device and the another electronic device;
outputting, via the display and based on the distance, the color;
encoding, via the color, information associated with an emergency situation and the distance, wherein the emergency situation corresponds to the emergency signal; and
rendering a change in the color based on a change in the distance.

16. The electronic device of claim 15, wherein the set of operations comprising determining the indication comprise:
determining, based on the first color or the second color, a nearest responder to dispatch to aid a user; and
transmitting a dispatch request to a device associated with the nearest responder.

17. The electronic device of claim 15, wherein the set of operations comprising calculating the distance comprises:
determining that the second computing device has received an emergency beacon transmitted by the first computing device; and
measuring a beaconing distance of the emergency beacon.

18. The electronic device of claim 15, wherein the set of operations comprising outputting the color comprises:
determining a color gradient that defines how the color varies as a function of the distance, wherein the color gradient is configured to facilitate routing the assistance to the user;
determining, based on the color gradient, the color according to a bullseye configuration;
changing, based on the color gradient, the color to another color based on a value of the distance; and
ceasing, based on the distance exceeding a threshold, to emit light of the color.

19. The electronic device of claim 15, wherein the set of operations further comprise:
encoding, via the color, information associated with the distance and an emergency situation experienced by the user; and
pulsing the color to represent data corresponding to the user.

20. The electronic device of claim 15, wherein the electronic device comprises at least one of: a wearable electronic device, a wrist band, a bracelet, an ankle band, a neck band, a portable cellular communications device.
